(19) United States
(12) Patent Application Publication
(10) Pub. No.: US 2010/0030346 A1
(43) Pub. Date: Feb. 4, 2010

(54) CONTROL SYSTEM AND CONTROL METHOD FOR CONTROLLING CONTROLLABLE DEVICE SUCH AS PERIPHERAL DEVICE, AND COMPUTER PROGRAM FOR CONTROL

(76) Inventor: Mitsuhiro Watanabe, Tokyo (JP)

Correspondence Address: Mr. Jackson Chen, 6535 N. STATE HWY 161, IRVING, TX, 75039, US

(21) Appl. No.: 12/525,598

(22) PCT Filed: Feb. 4, 2008
(86) PCT No.: PCT/JP2008/051730

§ 371 Date: Aug. 3, 2009

(30) Foreign Application Priority Data
Feb. 2, 2007 (JP) 2007-054096

(51) Int. Cl. G05B 19/02

(52) U.S. Cl. 700/7

(57) ABSTRACT

It is an object of the present invention to provide functions of a controllable device which a guest control means can control as an upper-limit range of functions controllable by a host control device. The controllable device is controlled by the host control means and the guest control means. The host control means stores a control program for controlling the controllable device, controls the controllable device according to the control program, intermediates between the guest control means and the controllable device, confirms a control request issued by the guest control means to the controllable device, and limits functions of the controllable device which can be controlled by the guest control means. The guest control means connects to the host control means and controls the controllable device according to the control program having the limited functions. A server may be provided to store the control program therein.

### TECHNICAL FIELD

The present invention relates to a scheme for controlling a peripheral device such as an electronic device, and more particularly to a control system, a control method, and a control computer program for allowing a user to use a controllable device which is a peripheral device connected via a network with limitations.

### BACKGROUND ART

Peripheral device control systems according to the background art will briefly be described below with reference to Patent document 1 (PA No. 2005-024594) and Patent document 2 (PA No. 2004-151938).

The peripheral device control system disclosed in Patent document 1 comprises a peripheral device such as a printer, a scanner, a facsimile device, or the like which is connected to a network and used by a plurality of users, a controller for controlling the peripheral device, and a server for holding user group information. Each of the users who uses a controllable device as the peripheral device belongs to any one of a plurality of groups, and its membership information is registered in the server.

The server also holds authentication information registered therein for the groups concerning the operation of a peripheral device (controllable device). The controllable device holds information about available functions and user information for each of the groups. When a user logs in a controllable device that the user is going to use, the controllable device asks the serve to authenticate the user. If the user is authenticated, functions that can be used by the group to which the user belongs are displayed on a display device, and the user selects a function that the user wants to use on the display screen.

Patent document 2 discloses an access authority transfer technology for enabling a user to transfer “part or all” of the access authority owned by the user to another user when a plurality of users do cooperative work using one or more computers.

Patent document 1: PA No. 2005-024594
Patent document 2: PA No. 2004-151938

### DISCLOSURE OF THE INVENTION

### Problems to be Solved by the Invention

When the peripheral device control system disclosed in Patent document 1 gives limitations about the operation of a controllable device to a user, the peripheral device control system needs to perform a complex process of managing the groups with respect to each of the limitations, registering the groups and the users belonging to the groups in the controllable device, and causing the controllable device to limit its operation. For using the controllable device, all users including guest users who temporarily use the controllable device need to be pre-registered in the controllable device. Furthermore, since the users are authenticated by the server, it is also necessary to register all the users in the server. Consequently, the peripheral device control system disclosed in Patent document 1 is problematic in that its management is highly complex.

The access authority transfer technology disclosed in Patent document 2 has a problem in that the transfer of access authority is performed in one terminal, and no consideration is given to any means for transferring authority to another terminal.

According to the present invention, when a host control means and a guest control means control a controllable device (peripheral device) that is connected to the same local network, the guest control means can control the controllable device through the host control means.

According to the present invention, functions of the controllable device which can be controlled by the guest control means can be provided as an upper-limit range of functions controllable by the host control means. Specifically, the functions of the controllable device that can be operated by the guest control means can be decreased from the functions that can be operated by the host control means, because the host control means can have the user thereof select functions which can be operated thereby, and can provide the selected functions to the guest control means.

According to the present invention, a permitted control means (control device) can operate the controllable device. Specifically, the control means adds a temporary connection key which has been authenticated by the controllable device and issued to the control means in advance, to a command for operating the controllable device, and the controllable device accepts the command of the control device if a previously issued connection key and the connection key added to the operation command are in conformity with each other.

### Means for Solving the Problems

(1) According to the present invention, there is provided a control system for controlling a controllable device such as a peripheral device, comprising server means for providing a control program for controlling the controllable device to a host control means and a guest control means, wherein said host control means controls the controllable device according to said control program, intermediates between the guest control means and the controllable device, limits functions of the controllable device which can be controlled by the guest control means, and confirms a control request issued by the guest control means to the controllable device, and said guest control means can be connected to the controllable device through the host control means.

(2) According to the present invention, there is provided a control system according to (1), wherein said guest control means controls the controllable device for the functions of the controllable device which can be controlled by the host control means as a maximum range of functions.

(3) According to the present invention, there is provided a control system according to (1) or (2), wherein a network between the host control means and the guest control means is logically separate from a network between the host control means and the controllable device or a network between the host control means and the server.

(4) According to the present invention, there is provided a control system according to any one of (1) through (3), wherein the host control means and the guest control means are of an identical configuration, and each have operation switching means which is set for determining whether each host control means and each the guest control means is to be operated as a host control means or a guest control means.

(5) According to the present invention, there is provided a control system according to any one of (1) through (4), wherein the host control means comprises an information processor, a user interface section serving as an interface with its own user, an authenticator for authenticating the controllable device, a controllable device function acquiring section for acquiring function information which the control device has, a controllable device controller for controlling the controllable device, means for relaying a control request to be sent from the guest control means to the controllable device, inspecting the control request before being relayed, and limiting the execution of the control request based on a pre-registered policy, and a communication section for communicating with the server means, the guest control means, and the controllable device.

(6) According to the present invention, there is provided a control system according to any one of (1) through (5), wherein the guest control means comprises an information processor, a user interface section serving as an interface with its own user, an authenticator for authenticating the controllable device, a controllable device function acquiring section for acquiring function information which the control device has, a controllable device controller for controlling the controllable device, a searcher for searching for the host control means, a host control means connector for connecting to the host control means which is searched for, and a communication section for communicating with the host control means.

(7) According to the present invention, there is provided a control system according to any one of (1) through (6), wherein the server means comprises an information processor, means for checking device information about the controllable device and the host control means or the guest control means against device information received through the host control means and held by itself, and selecting a function module as the control program provided to the host control means or the guest control means, an attribute adder for attaching attribute information to the function module, and a communication section for communicating with the host control means.

(8) According to the present invention, there is provided a control system according to any one of (1) through (7), wherein each host control means and each the guest control means comprises inspecting means for registering the attribute information attached to the function module received from the server means in a database, and for inspecting whether the function module stored in each of the control means can be operated or not based on the database, said inspecting means being interlinked with means for limiting operation of the function module.

(9) According to the present invention, there is provided a control system according to any one of (1) through (8), wherein the controllable device pre-records log-in information of the user of the host control means which uses the controllable device, determines whether log-in information sent from said host control means and the pre-recorded log-in information are in conformity with each other or not, and, if they are in conformity with each other, sends “device information for identifying itself” and “a connection key to be used when the host control means accesses the controllable device” to the host control means.

(10) According to the present invention, there is provided a control system according to (9), wherein said connection key has a randomly assigned value.

(11) According to the present invention, there is provided a control system according to (9) or (10), wherein if the controllable device confirms that log-in information of the user sent from said host control means and the log-in information recorded therein are in conformity with each other, the controllable device sends a function list thereof to the host control means.

(12) According to the present invention, there is provided a control system according to (11), wherein the host control means has the user thereof select functions which user wants to use from the function list received from the controllable device.

(13) According to the present invention, there is provided a control system according to (12), wherein the host control means has the user thereof select functions of the controllable device which the user of the guest control means is permitted to use.

(14) According to the present invention, there is provided a control system according to (13), wherein the host control means permits the user of the guest control means to use the functions of the controllable device which the host control means can use, as an upper-limit range of functions.

(15) According to the present invention, there is provided a control system according to any one of (1) through (14), wherein each host control means and each the guest control means comprises a mobile information communication terminal such as a mobile phone.

(16) According to the present invention, there is provided a control system for controlling a controllable device such as a peripheral device using host control means and guest control means, wherein said host control means holds a control program for controlling the controllable device, controls the controllable device according to the control program, provides the control program to the guest control means, intermediates between the guest control means and the controllable device when the guest control means controls the controllable device, limits functions of the controllable device which can be controlled by the guest control means, and confirms a control request issued by the guest control means to the controllable device, and said guest control means can be connected to the controllable device through the host control means.

(17) According to the present invention, there is provided a control system according to (16), wherein said guest control means controls the controllable device for the functions of the controllable device which can be controlled by the host control means as a maximum range of functions.

(18) According to the present invention, there is provided a control system according to (16) or (17), wherein a network between the host control means and the guest control means is logically separate from a network between the host control means and the controllable device.

(19) According to the present invention, there is provided a control system according to any one of (16) through (18), wherein the host control means and the guest control means are of an identical configuration, and each have operation switching means which is set for determining whether each host control means and each the guest control means is to be operated as a host control means or a guest control means.

(20) According to the present invention, there is provided a control system according to any one of (16) through (19), wherein the host control means comprises an information processor, a user interface section serving as an interface with its own user, an authenticator for authenticating the controllable device, a controllable device function acquiring section for acquiring function information which the control device has, a controllable device controller for controlling the controllable device, means for relaying a control request to be sent from the guest control means to the controllable device, inspecting the control request before being relayed, and limiting the execution of the control request based on a pre-registered policy, a communication section for communicating with the guest control means and the controllable device, means for receiving and checking device information about the controllable device against device information held by itself, and selecting a function module as the control program provided to the guest control means, and an attribute adder for attaching attribute information to the function module.

(21) According to the present invention, there is provided a control system according to any one of (16) through (19), wherein the guest control means comprises an information processor, a user interface section serving as an interface with its own user, an authenticator for authenticating the controllable device, a controllable device function acquiring section for acquiring function information which the control device has, a controllable device controller for controlling the controllable device, a searcher for searching for the host control means, a host control means connector for connecting to the host control means which is searched for, and a communication section for communicating with the host control means.

(22) According to the present invention, there is provided a control system according to any one of (16) through (21), wherein the guest control means comprises inspecting means for registering the attribute information attached to the function module received from the server means in a database, and inspecting whether the function module stored in each of the control means can be operated or not based on the database, said inspecting means being interlinked with means for limiting operation of the function module.

(23) According to the present invention, there is provided a control system according to any one of (16) through (22), wherein the controllable device pre-records log-in information of the user of the host control means which uses the controllable device, determines whether log-in information sent from said host control means and the pre-recorded log-in information are in conformity with each other or not, and, if they are in conformity with each other, sends “device information for identifying itself” and “a connection key to be used when the host control means accesses the controllable device” to the host control means.

(24) According to the present invention, there is provided a control system according to (23), wherein said connection key has a randomly assigned value.

(25) According to the present invention, there is provided a control system according to (23) or (24), wherein if the controllable device confirms that log-in information of the user sent from said host control means and the log-in information recorded therein are in conformity with each other, the controllable device sends a function list thereof to the host control means.

(26) According to the present invention, there is provided a control system according to (25), wherein the host control means has the user thereof select functions which user wants to use from the function list received from the controllable device.

(27) According to the present invention, there is provided a control system according to (26), wherein the host control means has the user thereof select functions of the controllable device which the user of the guest control means is permitted to use.

(28) According to the present invention, there is provided a control system according to (27), wherein the host control means permits the user of the guest control means to use the functions of the controllable device which the host control means can use, as an upper-limit range of functions.

(29) According to the present invention, there is provided a control system according to any one of (16) through (28), wherein each host control means and each the guest control means comprises a mobile information communication terminal such as a mobile phone.

(30) According to the present invention, there is provided a control method of controlling a controllable device such as a peripheral device with host control means or guest control means, wherein said host control means performs a process of having a user of the host control means enter log-in information to be sent to the controllable device, a process of sending the entered log-in information to the controllable device, a process of acquiring device information about the controllable device and a list of functions which the controllable device has from the controllable device, a process of having the user of the host control means select functions which the user of the host control wants to use from said function list, a process of sending said device information and a list of the functions selected by the user to a server, and requesting and acquiring a control program with control attributes, and a process of controlling the controllable device for functions permitted based on the control attributes attached to the acquired control program.

(31) According to the present invention, there is provided a control method according to (30), wherein said host control means performs a process of requesting the guest control means to send a connection key when the guest control means requests a connection to the host control means, a process of providing a list of controllable devices which can be used by the guest control means to the guest control means and having the guest control means select one of the controllable devices, a process of having an owner of the host control means select the controllable device selected by the guest control means and functions of the selected controllable device which can be used by the guest control means, within a range of functions which are used by the host control means, a process of sending a list of the functions selected by the owner of the host control means and device information of the controllable device to a server, and acquiring a program for controlling the controllable device, and a process of sending the acquired program to the controllable device.

(32) According to the present invention, there is provided a control method according to (30) or (31), wherein said host control means performs a process of relaying a control command requested by the guest control means for the controllable device to the controllable device, and a process of determining whether said control command is controllable or not based on control attribute information given to the guest control means, and sending the control command which is judged as controllable to the controllable device.

(33) According to the present invention, there is provided a control method according to any one of (30) through (32), wherein said guest control means performs a process of having an owner of the guest control means enter a connection key, a process of sending the connection key to the host control device, a process of selecting a controllable device, which the owner of the guest control means is desirous of using, from the list of controllable devices acquired from the host control means which can be used by the owner of the guest control means, a process of acquiring a program with control attributes of the selected controllable device from said server through said host control device, and a process of making the controllable device available through the host control means based on the control attributes attached to said program.

(34) According to the present invention, there is provided a control method according to (30), wherein said host control means performs a process of pre-registering user information including a user ID and a password of the user of the host control means in the controllable device, and the controllable device checks the pre-registered user information against user information which is sent when the host control means uses the controllable device, and, if the pre-registered user information and the sent user information are in conformity with each other, sends the device information of the controllable device to the host control means, and sends a connection key to be used when the host control means controls the controllable device and a list of functions which the controllable device has to the host control means.

(35) According to the present invention, there is provided a computer program for carrying out a control method according to any one of (30) through (34).

(36) According to the present invention, there is provided a control method of controlling a controllable device such as a peripheral device with host control means or guest control means, wherein said host control means performs a process of pre-storing a program for controlling functions of the controllable device, said host control device performs a process of having a user of the host control means enter log-in information to be sent to the controllable device, a process of sending the entered log-in information to the controllable device, a process of receiving device information about the controllable device and acquiring a list of functions which the controllable device has from the controllable device, a process of having the user of the host control means select functions which the user of the host control means wants to use from the list of functions, a process of identifying a control program from said device information and a list of the functions selected by the user, and a process of controlling the controllable device for “functions permitted” based on control attributes added to the identified control program.

(37) According to the present invention, there is provided a control method according to (36), wherein said host control means performs a process of requesting the guest control means to send a connection key when the guest control means requests a connection to the host control means, a process of providing a list of controllable devices which can be used by the guest control means to the guest control means and having the guest control means select one of the controllable devices, a process of having an owner of the host control means select the controllable device selected by the guest control means and functions of the selected controllable device which can be used by the guest control means, within a range of functions which are used by the host control means, a process of identifying a program controllable by the guest control means based on a list of the functions selected by the owner of the host control means and device information of the controllable device, and a process of sending the identified program to the controllable device.

(38) According to the present invention, there is provided a control method according to (36) or (37), wherein said host control means performs a process of relaying a control command requested by the guest control means for the controllable device to the controllable device, and a process of determining whether said control command is controllable or not based on control attribute information given to the guest control means, and sending the control command which is judged as controllable to the controllable device.

(39) According to the present invention, there is provided a control method according to any one of (36) through (38), wherein said guest control means performs a process of having an owner of the guest control means enter a connection key, a process of sending the connection key to the host control device, a process of selecting a controllable device, which the owner of the guest control means is desirous of using, from the list of controllable devices acquired from the host control means which can be used by the owner of the guest control means, a process of acquiring a program with control attributes of the selected controllable device from said server through said host control device, and a process of making the controllable device available through the host control means based on the control attributes attached to said program.

(40) According to the present invention, there is provided a control method according to (36), wherein said host control means performs a process of pre-registering user information including a user ID and a password of the user of the host control means in the controllable device, and the controllable device checks the pre-registered user information against user information which is sent when the host control means uses the controllable device, and, if the pre-registered user information and the sent user information are in conformity with each other, sends the device information of the controllable device to the host control means, and sends a connection key to be used when the host control means controls the controllable device and a list of functions which the controllable device has to the host control means.

(41) According to the present invention, there is provided a computer program for carrying out a control method according to any one of (36) through (40).

### Advantages of the Invention

According to the present invention, when the host control means and the guest control means control the controllable device (peripheral device) that is connected to the same local network, the guest control means can control the controllable device through the host control means. Therefore, the guest control means is prevented from carrying out an unauthorized process to control the controllable device on its own.

According to the present invention, functions of the controllable device which can be controlled by the guests control means can be provided as an upper-limit range of functions controllable by the host control means. Specifically, the functions of the controllable device that can be operated by the guests control means can be decreased from the functions that can be operated by the host control means, because the host control means can have the user thereof select functions which can be operated thereby, and can provide the selected functions to the guest control means.

According to the present invention, the control means adds a temporary connection key which has been authenticated by the controllable device and issued to the control means in advance, to a command for operating the controllable device, and the controllable device accepts the command of the control device if a previously issued connection key and the connection key added to the operation command are in conformity with each other. Consequently, the permitted control means (control device) is able to operate the controllable device.

### BRIEF DESCRIPTION OF THE DRAWINGS

FIG. 1 is a diagram illustrative of a first exemplary embodiment of the present invention;

FIG. 2 is a diagram illustrative of details of the configuration shown in FIG. 1;

FIG. 3 is a diagram showing the configuration of a control means shown in FIG. 1;

FIG. 4 is a diagram showing a configuration in which the control means shown in FIG. 3 is used as a host control means;

FIG. 5 is a diagram showing a configuration in which the control means shown in FIG. 3 is used as a guest control means;

FIG. 6 is a diagram showing the configuration of a controllable device shown in FIG. 1;

FIG. 7 is a diagram illustrative of a server shown in FIG. 1;

FIG. 8 is a diagram showing details of a portion of the host control means shown in FIG. 4;

FIG. 9 is a flowchart illustrative of operation of the first exemplary embodiment;

FIG. 10 is a flowchart illustrative of operation of the first exemplary embodiment;

FIG. 11 is a flowchart illustrative of operation of the first exemplary embodiment;

FIG. 12 is a flowchart illustrative of operation of the first exemplary embodiment;

FIG. 13 is a flowchart illustrative of operation of the first exemplary embodiment;

FIG. 14 is a diagram showing an example of the content of a policy database used in the first exemplary embodiment;

FIG. 15 is a diagram illustrative of the manner in which the functions of the controllable device that can be used by the host control means according to the first exemplary embodiment are decreased and used by the guest control means;

FIG. 16 is a diagram illustrative of the manner in which the functions of the controllable device that can be used by the host control means according to the first exemplary embodiment are decreased and used by the guest control means;

FIG. 17 is a diagram illustrative of the manner in which the functions of the controllable device that can be used by the host control means according to the first exemplary embodiment are decreased and used by the guest control means;

FIG. 18 is a diagram illustrative of the manner in which the functions of the controllable device that can be used by the host control means according to the first exemplary embodiment are decreased and used by the guest control means;

FIG. 19 is a diagram illustrative of a second exemplary embodiment of the present invention;

FIG. 20 is a diagram illustrative of a third exemplary embodiment of the present invention;

FIG. 21 is a diagram illustrative of a fourth exemplary embodiment of the present invention;

FIG. 22 is a diagram showing another example of the content of the policy database shown in FIG. 14;

FIG. 23 is a diagram illustrative of a fifth exemplary embodiment of the present invention;

FIG. 24 is a diagram illustrative of the fifth exemplary embodiment of the present invention;

FIG. 25 is a diagram illustrative of the fifth exemplary embodiment of the present invention;

FIG. 26 is a diagram illustrative of the fifth exemplary embodiment of the present invention;

FIG. 27 is a diagram illustrative of example 1 of the present invention;

FIG. 28 is a diagram illustrative of example 2 of the present invention; and

FIG. 29 is a diagram illustrative of example 3 of the present invention.

### DESCRIPTION OF REFERENCE CHARACTERS

100 server

101 host control means

102 guest control means

103 controllable device

104 host user

105 guest user

106 wireless station

107 router

108 Internet

200 information processor

201 controllable device managing means

202 guest control means managing means

203 host control means coordinating means

204 communication means

205 UI means

206 host/guest selecting means

300 information processor

301 controllable device individual section

302 communication means

400 information processing function

401 device information checking section

402 provided module

403 attribute adder

404 communication section

501 operating system

502 policy database checker

### BEST MODE FOR CARRYING OUT THE INVENTION

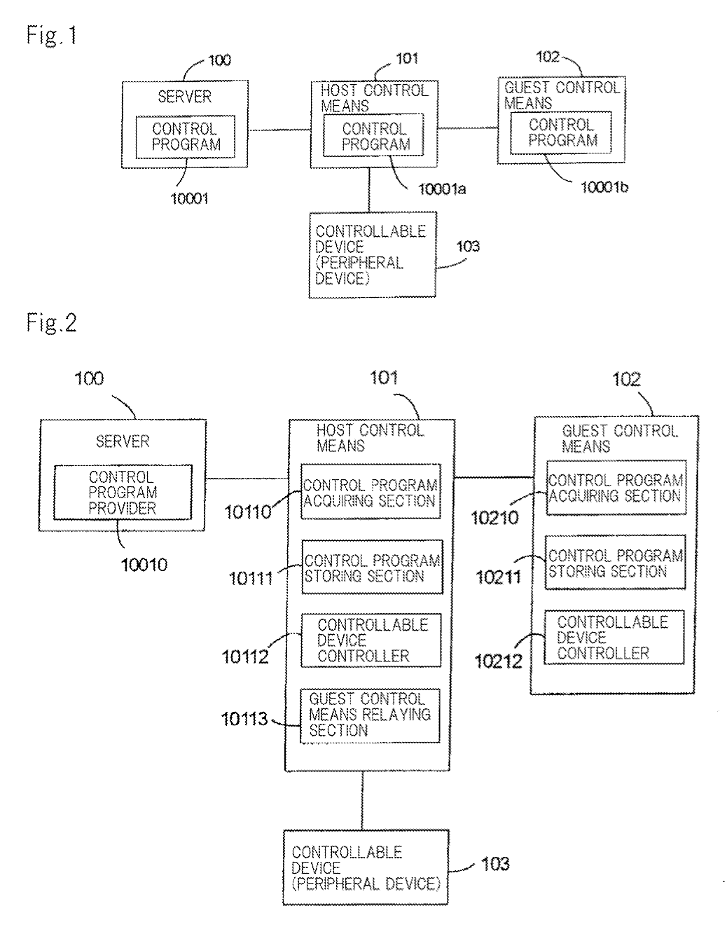

A first exemplary embodiment of the present invention will be described with reference to FIGS. 1 through 18.

A control system for controlling a controllable device such as a peripheral device as shown in FIG. 1 comprises server 100, host control means 101, guest control means 102, controllable device 103 as a peripheral device, etc. Server 100 is provided on a network, and server 100 and host control means 101, host control means 101 and guest control means 102, host control means 101 and controllable device 103 are connected to each other by respective ad-hoc mode networks.

Host control means 101 and guest control means 102 comprise, for example, control means disposed in a mobile information communication terminal such as a PDA (Personal Digital Assistant), a mobile phone, or the like which has a communication function. Controllable device 103 comprises, for example, an information device or a home electric appliance controllable by a remote controller or the like such as a video recorder/reproducer, a television set, an air conditioner, or the like.

Server 100 stores control program 10001. Control program 10001 is a program for host control means 101 and guest control means 102 to control controllable device 103. Server 100 provides the program to host control means 101 and guest control means 102. In FIG. 1, control programs provided from server 100 to host control means 101 and guest control means 102 are denoted respectively by 10001a, 10001b.

Host control means 101 has a function to control controllable device 103 according to control program 10001a, and also to relay information between guest control means 102 and controllable device 103. Furthermore, host control means 101 confirms a control request issued by guest control means 102 to controllable device 103, and limits the control of guest control means 102 over controllable device 103. Guest control means 102 controls controllable device 103 according to control program 10001b whose functions are limited (or whose function are not limited) via host control means 101. In other words, controllable device 103 is controlled by guest control means 102 or host control means 101.

The configuration shown in FIG. 1 will be described in greater detail with reference to FIG. 2.

Host control means 101 includes control program acquiring section 10110 which acquires control program 10001a (FIG. 1) by sending a request to control program provider 10010 of server 100, and which stores control program 10001a in control program storing section 10111. Host control means 101 also has controllable device controller 10112 which controls controllable device 103 by executing control program 10001a that is stored.

Guest control means 101 includes control program acquiring section 10210 which requests control program provider 10010 of server 100 to acquire a control program via guest control means relaying section 10113 of host control means 101, and stores the acquired control program as control program 10001b (FIG. 1) in control program storing section 10211. Controllable program controller 10212 executes control program 10001B that is stored to control controllable device 103 via host control means 101.

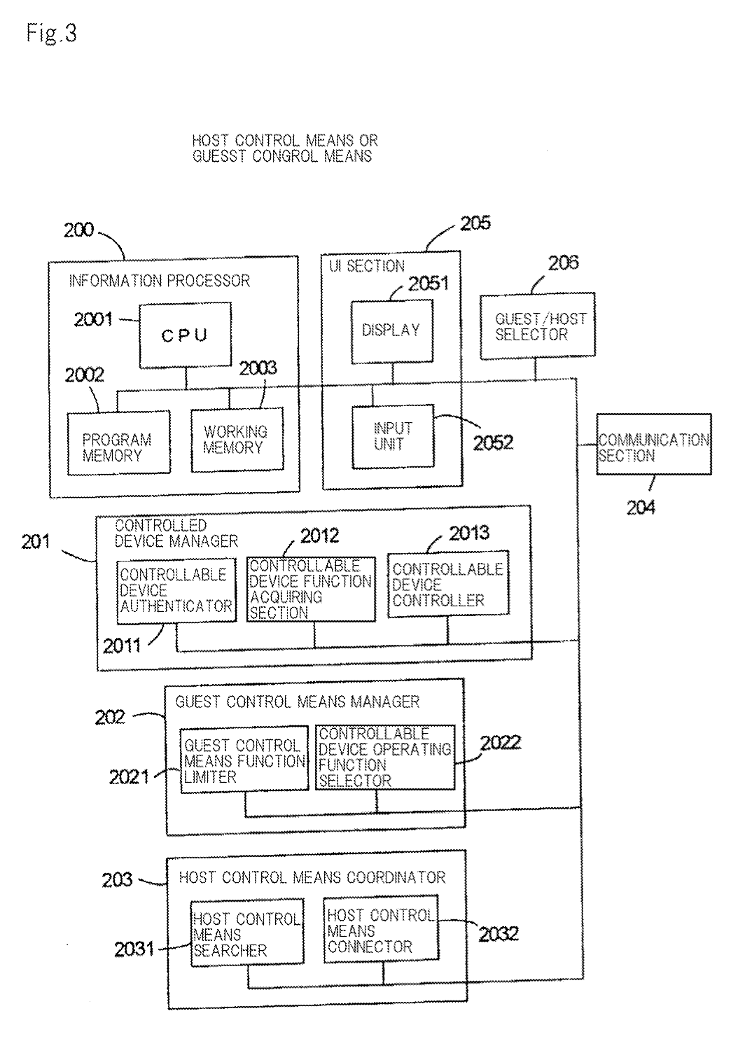

FIG. 3 shows the configuration of a means that is used as the host control means or the guest control means. Specifically, if the user operates host/guest selector 206 to select it for use as the host control means, then the means shown in FIG. 3 functions as the host control means. Conversely, if the user operates host/guest selector 206 to select it for use as the guest control means, then the means functions as the guest control means.

The means shown in FIG. 3 comprises, in addition to host/guest selector 206, information processor 200, controllable device manager 201, guest control means manager 202, host control means coordinator 203, communication section 204, and UI (User Interface) section 205.

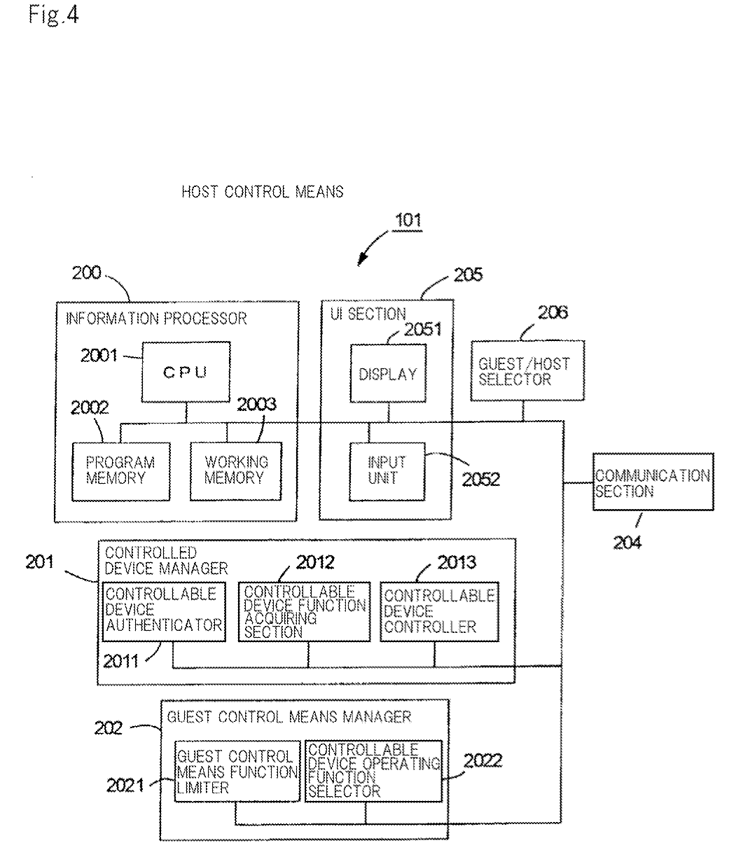

FIG. 4 shows a configuration in which the means shown in FIG. 3 is used as the host control means. Since host control means coordinator 203 shown in FIG. 3 is not used in the host control means, it is not illustrated.

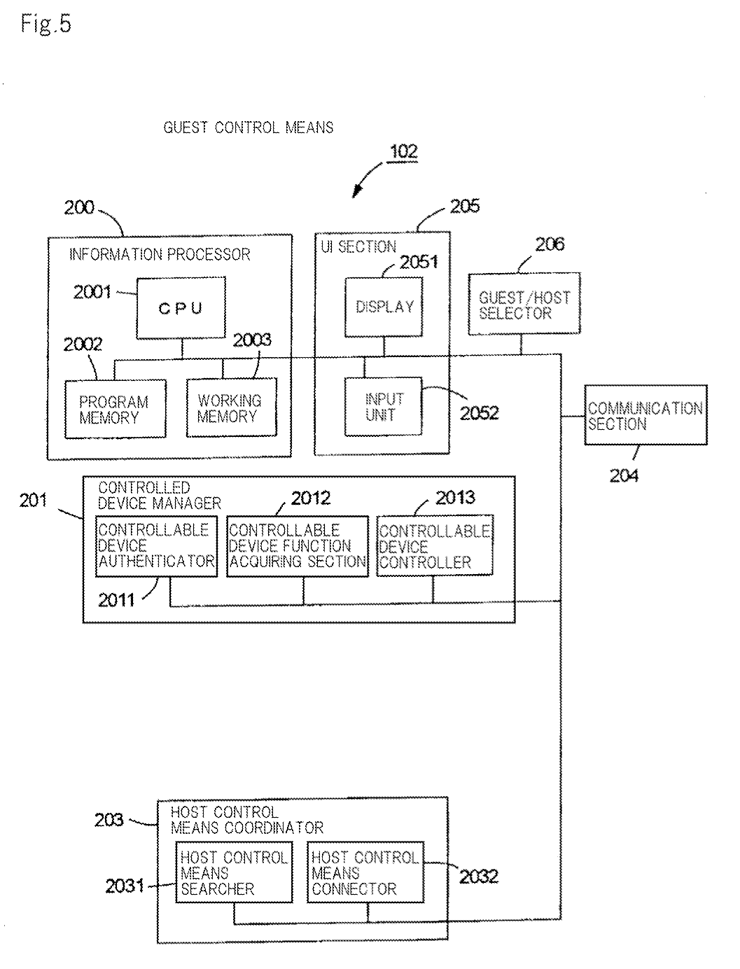

FIG. 5 shows a configuration in which the means shown in FIG. 3 is used as the guest control means. Since guest control means manager 202 shown in FIG. 3 is not used in the guest control means, it is not illustrated.

Communication section 204 shown in FIG. 4 is used to connect host control means 101 to server 100, guest control means 102, and controllable device 103. Communication section 204 shown in FIG. 5 is used to connect guest control means 102 to host control means 101.

In FIGS. 3 through 5, information processor 200 comprises CPU (Central Processing Unit) 2001, program memory 2002, and working memory 2003. UI section 205 comprises display 2051 and input unit 2052. Host/guest selector 206 makes its selection using display 2051 and input unit 2052 of UI section 205. Controllable device manager 201 comprises controllable device authenticator 2011, controllable device function acquiring section 2012, and controllable device controller 2013. Guest control means manager 202 (FIGS. 3 and 4) comprises guest control means function limiter 2021 and controllable device operating function selector 2022. Host control means coordinator 203 (FIGS. 3 and 5) comprises host control means searcher 2031 and host control means connector 2032.

When host control means 101 is to operate controllable device 103, host control means 101 directly controls controllable means 103 according to the control program acquired from server 100. When guest control means 102 is to operate controllable device 103 via host control means 101, host control means 101 causes guest control means function limiter 2021 shown in FIG. 4 to limit the operation of guest control means 102.

In preparation for guest control means 102 to operate controllable device 103, guest control means 102 connects itself to host control means 101 to secure a communication route for relaying information to and from controllable device 103, and then acquire the control program for controllable device 103 from server 100 via host control means 101.

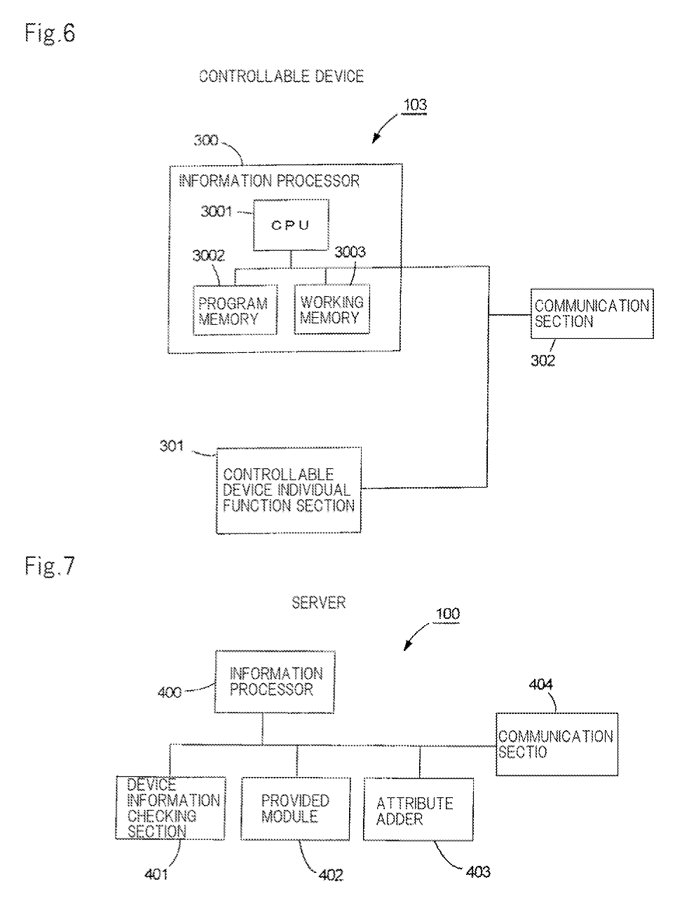

FIG. 6 shows in block form the functions of controllable device 103 (FIG. 1). As shown in FIG. 6, controllable device 103 comprises information processor 300, controllable device individual function section 301, and communication section 302. Information processor 300 includes a CPU which controls controllable device individual function 301 according to a control program stored in program memory 30002. For example, if the controllable device is a video device, then playback, stop, and recording functions are performed as controllable device individual functions. Information processor 300 communicates with host control means 101 through communication section 302.

FIG. 7 is a block diagram illustrative of the functions of server 100. Server 100 comprises information processor 400, device information checking section 401, provided module 402, attribute adder 403, and communication section 404. Server 100 performs its own functions using information processor 400. Information processor 400 comprises a CPU, a program memory, and a working memory, not shown, as with controllable device 103. Device information checking section 401 checks “respective device information of controllable device 103 and host control means 101” sent from host control means 101 or “respective device information of guest control means 102 and controllable device 103” sent from the guest control means via host control means 101 against provided module (provided program) 402, and selects and provides a control program for the controllable device which differs depending on the type of the host or guest control means. Provided module 402 stores therein appropriate programs matching CPUs and device functions which the host and guest control means have and also device functions of the controllable device. Attribute adder 403 will be described later.

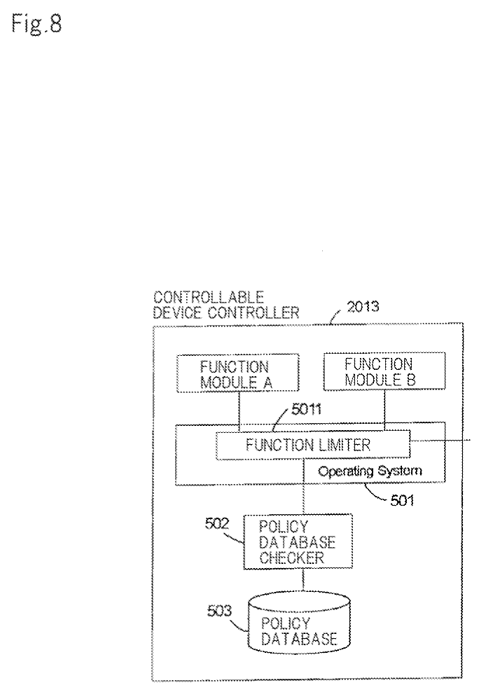

FIG. 8 is a diagram illustrative of function limitations for host control means 101 (FIG. 4) to operate controllable device 103 on behalf of guest control means 102. FIG. 8 shows details of controllable device controller 2013 shown in FIG. 4 and also shows guest control means function limiter 2021.

As shown in FIG. 8, controllable device controller 2013 holds function modules A, B, for example. Function modules A, B serve to operate controllable device 103, and are delivered from server 100 as provided modules to host control means 101. The number of function modules acquired from server 100 differs depending on the functions of controllable device 103, and is not limited to two as shown. For example, if the controllable device is a video device, then the function modules correspond respectively to the playback, stop, and recording functions. Though not shown in FIG. 8, each of the function modules has an attribute (to be described later) serving as a criterion for determining whether its operation is alright or not. Controllable device controller 2013 further has OS (Operating System) 501 which is a basic system for operating each program. The OS has function limiter 5011 for limiting the operation of each function module depending on the policy.

For example, it is assumed that function module A is registered as an operation that is permitted and function module B as an operation that is not permitted. When function module B attempts to access controllable device 103 via communication section 204, function limiter 5011 sends a confirmation request to refer to policy database 503 to policy database checker 502. Since function module B is registered as an operation that is not permitted in policy database 503, policy database checker 502 returns an unpermitted message to function limiter 5011 to block operation of function module B. On the other hand, as function module A is registered as an operation that is permitted in policy database 503, function module A is capable of accessing communication section 204 and operating controllable device 103.

Guest control means 102 also has a function limiter which corresponds to function limiter 5011 shown in FIG. 8. The function limiter of guest control means 102 limits functions based on data stored in a policy database (corresponding to 503 shown in FIG. 8) thereof. Host control means 101 determines relaying control commands requested by guest control means 102 and which host control means has permitted to be given. Therefore, the policy database (corresponding to 503 shown in FIG. 8) of guest control means 102 holds links of the function modules of guest control means 102 and their attributes, registered therein. Information about the attributes is attached to the function modules by attribute adder 403 (FIG. 7) of server 100.

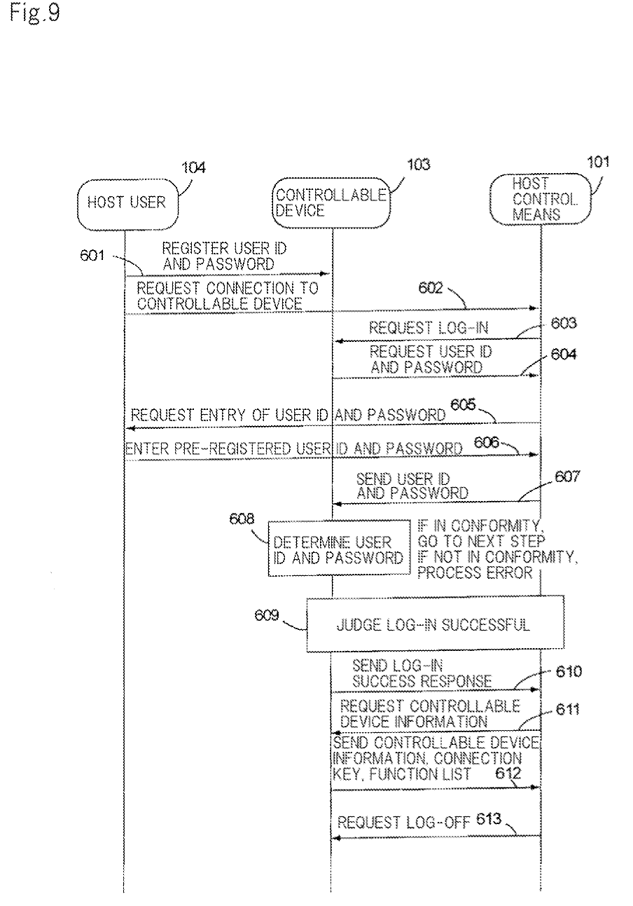

Operation of the first exemplary embodiment will be described below with reference to flowcharts shown in FIGS. 9 through 13. The functional blocks shown in FIGS. 3 through 5 may also be referred to in the description of the flowcharts.

FIG. 9 is a diagram illustrative of a sequence for host control means 101 to log in controllable device 103 in order that host control means 101 can use (control) controllable device 103.

First, host user (a person who uses host control means 101) 104 registers a user ID and a password in controllable device 103 (step 601). When host user 104 subsequently wants to use controllable device 103, host user 104 requests host control means 101 to connect to controllable device 103 (step 602). In response to the request, host control means 101 authenticates controllable device 103 using controllable device authenticator 2011 (FIG. 4), and issues a log-in request to controllable device 103 (step 603). When controllable device 103 receives the log-in request, controllable device 103 asks the requester, i.e., host control means 101, for the user ID and the password (step 604). In response to the request, host control means 101 prompts host user 104 to enter the user ID and the password, using display 2051 of UI section 205 (FIG. 4) (step 605).

When host user 104 enters the user ID and the password for controlling controllable device 103 into host control means 101 (step 606), host control means 101 sends the user ID and the password that have been entered to controllable device 103 (step 607). Controllable device 103 determines whether or not the user ID and the password that have been received are in conformity with the user ID and the password that have been registered (step 608). If they are in conformity with each other, then it is judged that the log-in is successful (step 609), and controllable device 103 sends a log-in success response to host control means 101 (step 610). If the user ID and the password are not in conformity with the user ID and the password that have been stored, then controllable device 103 sends a log-in failure response.

When host control means 101 receives the log-in success response, host control means 101 asks controllable device 103 for controllable device information such as “manufacturer (maker) and type number” to identify the controllable device (device type) (step 611). The controllable device information is used as information based on which server 100 will identify control programs. Controllable device 103 sends the controllable device information, a connection key, and a function list representing the functions held by controllable device 103 (step 612).

A connection key is randomly generated each time a request for controllable device information is issued. The connection key is also stored in controllable device 103 in relation to information which individually identifies host control means 101, such as a unique ID of host control means 101. When host control means 101 receives the above information, host control means 101 sends a log-off request (step 613) to cut off the link with controllable device 103.

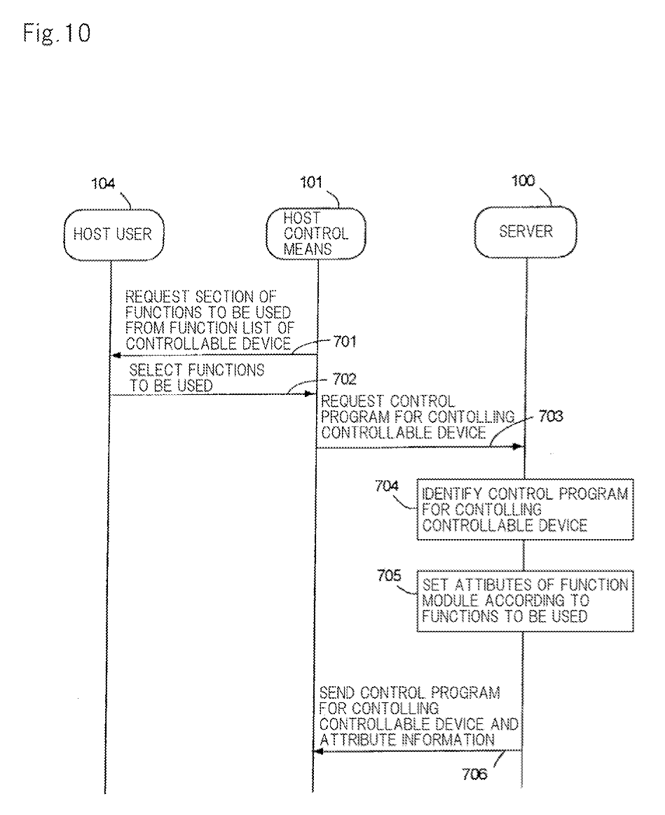

A sequence for host control means 101 to acquire a control program for controlling controllable device 103 from server 100 will be described below with reference to FIG. 10.

When host user 104 requests host control means 101 to acquire a control program via UI section 205, host control means 101 requests host user 104 to select functions to be actually used from the function list of the controllable device which has been acquired in the log-in sequence shown in FIG. 9 (step 701). In response to the request, host user 104 selects the functions to be used and enters the functions into host control means 101 (step 702). Host control means 101 issues a request for a controllable device control program together with a list representing the functions selected by host user 104, to server 100 (step 703). Server 100 identifies a function module group which is a program for controlling the controllable device (step 704), sets attributes of function modules according to functions to be used based on the above “list representing the selected functions” (step 705), and sends attribute information together with the control program (the function module group) (step 706).

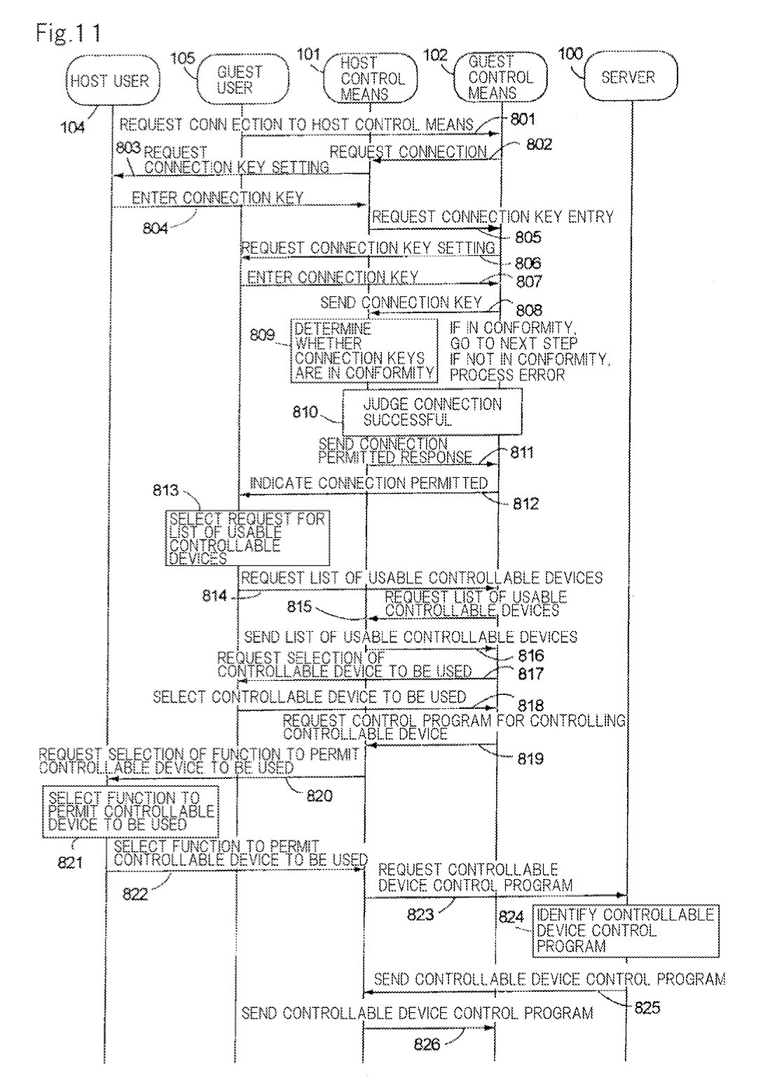

Operation of guest control means 102 for acquiring a program for controlling controllable device 103 from server 100 will be described below with reference to FIG. 11.

It is assumed that host control means 101 and guest control means 102 are in the same execution environment, and that the software for controlling a certain controllable device (e.g., control device 103) is a software platform which is capable of operating either host control means 101 or guest control means 102.

Guest user 105 who uses guest control means 102 requests guest control means 102 to connect to host control means 101 using an UI function (UI section 205) thereof (step 801). When guest control means 102 receives the connection request, guest control means 102 searches for an external control means and outputs a connection request to host control means 101 that is found, using host control means searcher 2031 and host control means connector 2032 (step 802).

When host control means 101 receives the connection request, host control means 101 prompts host user 104 to enter a connection key to be used for guest control means 102 to connect to host control means 101, using display 2051 of UI section 205 (step 803). When host user 104 enters a connection key using display 2051 of UI section 205 (step 804), host control means 101 issues a connection key input request to guest control means 102 (step 805).

Guest control means 102 prompts guest user 105 to enter a connection key, using display 2051 of UI section 205 (step 806), and guest user 105 enters a connection key (step 807). Thereafter, guest control means 102 sends the entered connection key to host control means 101 (step 808). If host control means 101 judges that the connection key from host user 104 and the connection key from guest user 105 are in conformity with each other (step 809), the host control means 101 judges that the connection is successful (step 810), and sends a connection permitted response to guest control means 104 (step 811). In order for host user 104 and guest user 105 to be able to enter the same connection key, host user 104 may indicate in advance the connection key set in host control means 101 to guest user 105.

When guest control means 102 receives the response from host control means 101, guest control means 102 indicates to guest user 105 that the connection to host control means 101 is permitted (step 812). Guest user 105 selects “acquire list of usable controllable devices” from a menu displayed on display 2051 of guest control device 102 (step 813). Guest user 105 issues a usable controllable device list request to guest control means 102 (step 814). Then, guest control means 102 issues the usable controllable device list request to host control means 101 (step 815), which, in response to the request, sends a list of usable controllable devices which have been searched for and stored in advance to the controllable device (step 816).

When guest control means 102 receives the list, guest control means 102 prompts guest user 105 to select a controllable device which guest user 105 wants to use, using display 2051 of UI section 205 (step 817). When guest user 105 selects and enters a controllable device which guest user 105 wants to use (step 818), guest control means 102 issues a request for a control program for the selected controllable device to host control means 101 (step 819).

In response to the request from guest control means 102, host control means 101 prompts host user 104 to select “a function to permit the selected controllable device to be used” (step 820). Host user 104 selects a function, which a user of the host control is permitted to use on display 2051 of UI section 205 (step 821), and enters the selected result (step 822). These steps are carried out using guest control means function limiter 2021 and controllable device operation selector 2022.

In response to the input from host user 104, host control means 101 issues a request for a program for enabling the guest control means to operate the controllable device, to server 100 (step 823). At this time, host control means 101 sends, together with the program request, “controllable device information for identifying itself” sent from controllable device 103 to server 100. Server 100 identifies a controllable device control program from the controllable device information, and sends the controllable device control program to host control means 101 (step 825). When host control means 101 receives the controllable device control program from server 100, host control means 101 sends the received control program to guest control means 102 (step 826).

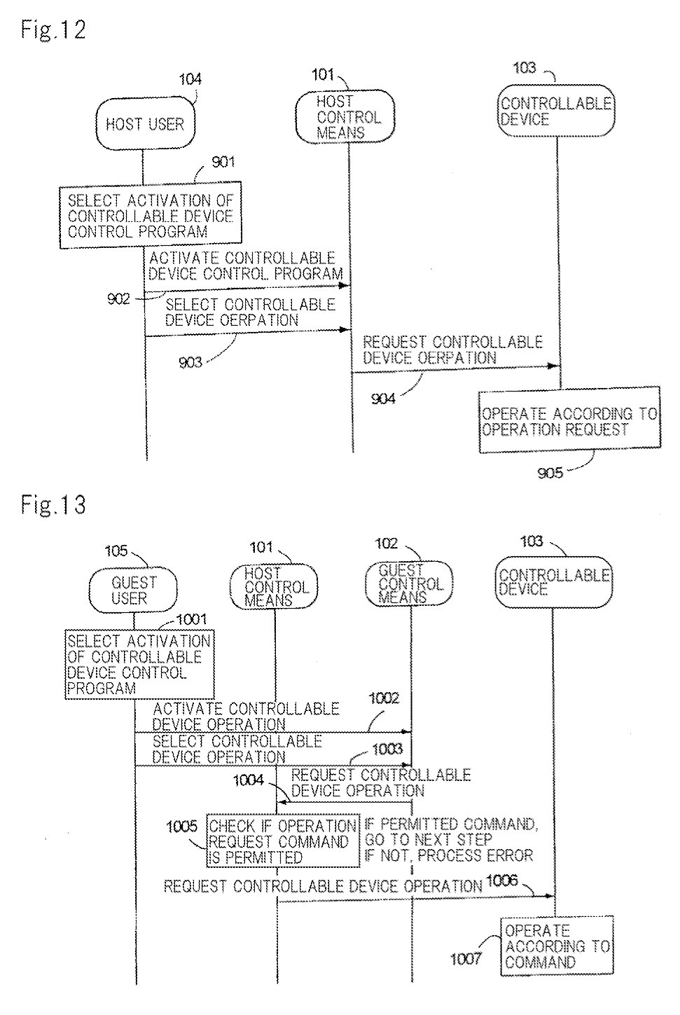

FIG. 12 is a flowchart illustrative of a sequence for host control means 101 to control controllable device 103.

When host user 104, which is the owner of host control means 101, wants to operate controllable device 103 using host control means 101, host user 104 selects an activation menu for the controllable device control program acquired by the sequence shown in FIG. 10, using display 2051 of UI section 205 (step 901). Then, host user 104 requests host control means 101 to activate the controllable device program (step 902), and selects operation of controllable device 103 using the activated program (step 903). Then, host control means 101 sends a request to operate the controllable device to controllable device 103, using controllable device controller 2013 (step 904). In response to the operation request, controllable device 103 operates according to the selected operation request (step 905).

FIG. 13 is a flowchart illustrative of a sequence for guest control means 102 to control controllable device 103.

As shown in FIG. 13, when user 105 of guest control means 102 uses guest control means 102 to operate controllable device 13, user 105 selects an activation menu for the controllable device control program acquired by the sequence shown in FIG. 11, using display 2051 of UI section 205 (step 1001). Then, guest user 105 requests guest control means 102 to activate the controllable device program (step 1002), and selects operation of the controllable device (step 1003). Then, guest control means 102 activates the controllable device program, and, depending on the selection of the operation request, sends a controllable device operation request to host control means 101 via host control means connector 2032 of host control means coordinator 203 (FIG. 5) (step 1004).

Host control means 101 checks if an operation request command sent from guest control means 102 is permitted or not, using guest control means function limiter 2021 (step 1005). Host control means 101 checks if the operation request command is permitted or not based on the data stored in policy database 503 shown in FIG. 8. If the operation request command is permitted based on the check, then host control means 101 issues a controllable device operation request to controllable device 103 on behalf of guest control means 102 (step 1006). On the other hand, if the operation request command is not permitted, then host control means 101 sends an error response to guest control means 102. In response to the operation request, controllable device 103 operates according to commands (step 1007).

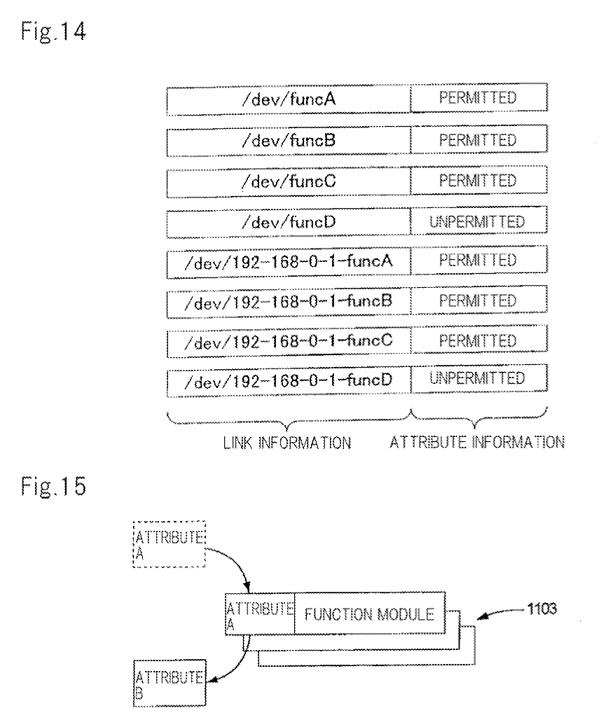

FIG. 14 is a diagram showing an example of the content of the policy database described above. The policy database comprises link information and attribute information. The link information represents storage locations for function modules of host control means 101 and guest control means 102, such as /dev/funcA or /dev/192-168-0-1-funcA, and the attribute information represents attributes set in function modules.

A sequence for degenerating the functions of controllable device 103 which can be used by host control device 101 and for allowing guest control means 102 to use the decreased functions will be described below with reference to FIGS. 15 through 18.

As shown in FIG. 15, attribute A or B for specifying the operation of a function module is attached to each of a plurality of function modules 1103. It is assumed that attribute B is an attribute for permitting the operation of a module, and attribute A is an attribute for unpermitting the operation of a module. An attribute represents information that is attached by server 100 upon request from host control means 101. Attribute B is attached in advance to the function modules which are stored in server 100. Host control means 101 is aware in advance of the functions which controllable device 103 has. Host control means 101 indicates to server 100 which functions of controllable device 103 will be used by host control means 101, and obtains a function module group from server 100. If host control means 101 requests functions with attribute A, then server 100 removes attribute B that has originally been attached to the functions and adds attribute A instead, or alternatively overwrites attribute B with attribute A. In this manner, server 100 generates function module 1103 whose attribute has changed from attribute B to attribute A. Function modules with a changed attribute and function modules with an unchanged attribute are put together and temporarily stored in a working memory of information processing function 400 of server 100. Changing between attribute A and attribute B is conditionally irreversible. If attribute B has been changed to attribute A, then it is impossible for anyone, except those who have privileges such as the administrator of server 100, to change attribute A to attribute B again.

As shown in FIG. 16, functions 1201 which controllable device 103 has range from function 1 to function 4, for example. Function modules for controlling these functions include function module 1 assigned to function 1, function module 2 to function 2, and so on. If the functions that can be used by host control means 101 range from function 1 to function 3, then an attribute for permitting operation is added to function module 1, function module 2, and function module 3, and an attribute for unpermitting operation is added to function module. When the host user is to transfer function modules to guest control means 102, if the host user wants to limit the function of function module 3 in addition to function module 4, then server 100 changes the permission attribute to the unpermission attribute upon request from host control means 101, and sends the function modules with the changed attributes to guest control means 102 via host control means 101. When these attributes are stored in host control means 101 and guest control means 102, they, together with links representing information as to destinations where the function modules are to be stored, are registered in policy database 503.

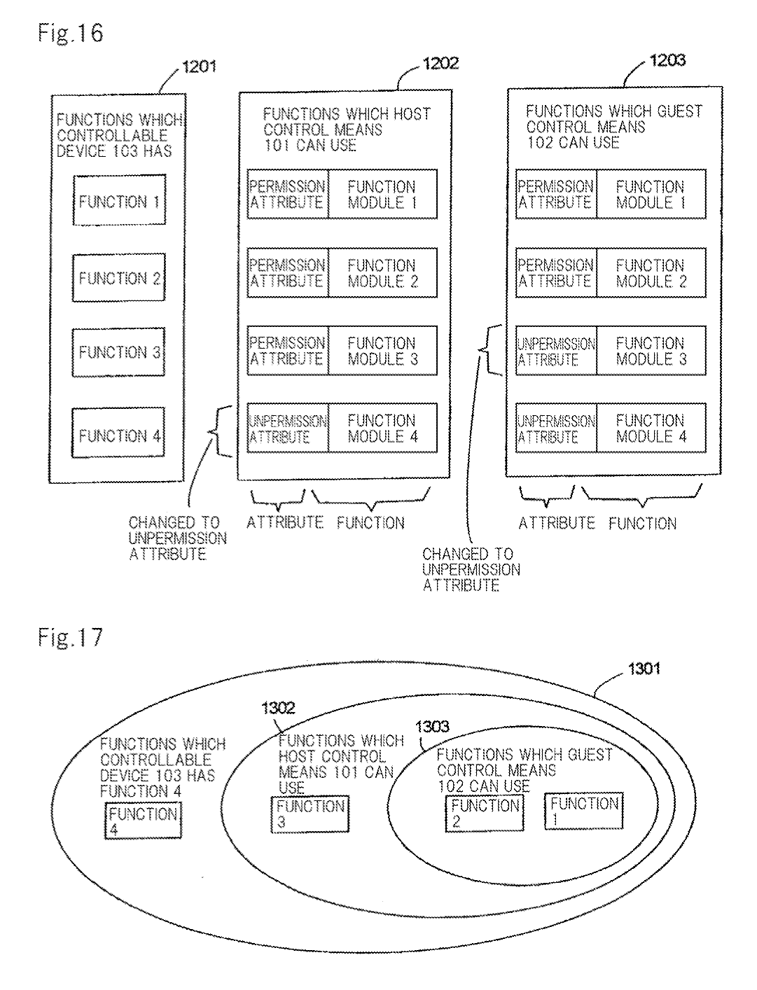

FIG. 17 is a diagram schematically showing the relationship between functions 1301 which controllable device 103 has, functions 1302 which host control means 101 can use, and functions 1303 which guest control means 102 can use. Controllable device 103 has all functions 1 through 4, for example. Host control means 101 can use functions 1 through 3, and guest control means 103 can use functions 1, 2.

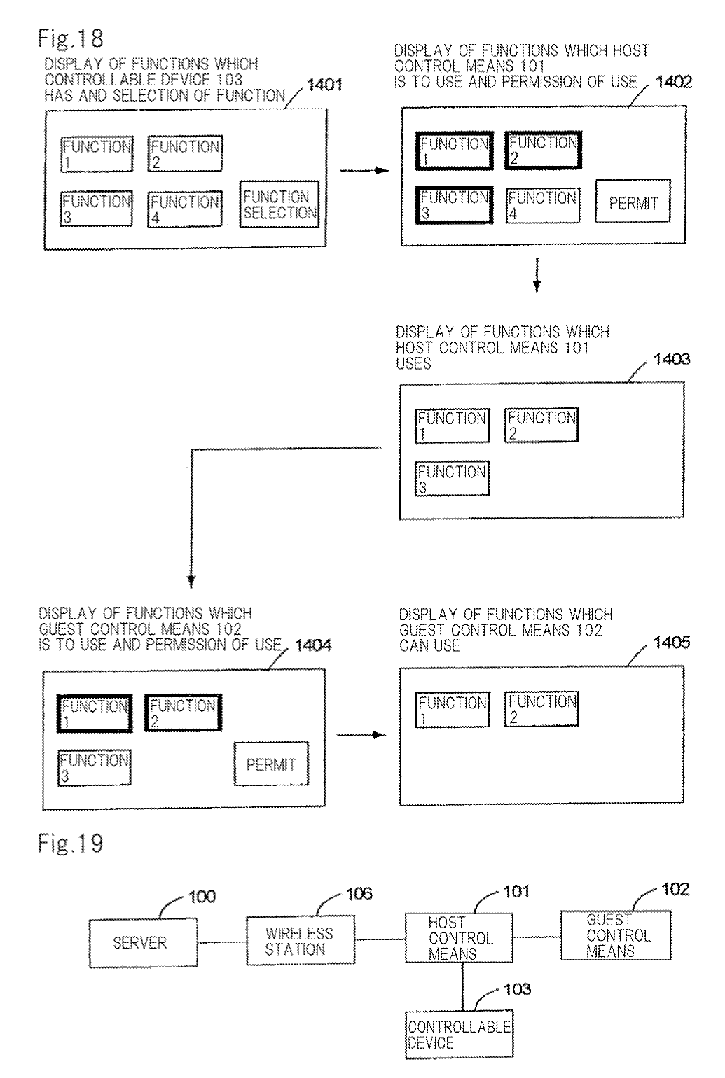

FIG. 18 is a diagram illustrative of an operation which the host user performs to select a function from “the functions of controllable device 103” displayed on display 2051 (see FIG. 4) of host control means 101, and an operation which host user 104 performs to permit guest control means 102 to use some of “the functions of controllable device 103”.

It is assumed that the functions of controllable device 103 which can be used by host control means 101 and guest control means 102 are “functions 1 through 3” and “functions 1, 2”, respectively.

First, functions 1 through 4 which controllable device 103 has are displayed on display 2051 of host control means 101 (1401 in FIG. 18). When host user 104 selects functions 1 through 3 on display screen 1401, selected functions 1 through 3 are highlighted, and a permission button is displayed. When host user 104 presses the permission button, the display screen changes to display screen 1403 displaying “selected functions 1 through 3” which can be used by host control means 101.

If host user 104 permits guest control means 102 to use the functions of controllable device 103, then host user 104 selects functions 1, 2 from the functions that can be used by host control means 101. When host user 104 presses the permission button (display screen 1404), functions 1, 2 which are permitted for guest control means 102 are displayed (display screen 1405).

The function which is not selected may be deleted from the display screen as shown, or may be grayed out on the display screen, indicating that the function is not selected or cannot be used.

FIG. 19 is a diagram illustrative of a second exemplary embodiment of the present invention. Comparison between the second exemplary embodiment and the first exemplary embodiment indicates that the second exemplary embodiment is different therefrom in that it has wireless station 106. Therefore, components other than the wireless station are denoted by reference characters that are identical to those shown in FIG. 1. Wireless station 106 is present in a wireless local area network (LAN), and server 100 is present in a wired LAN. Host control means 101 and guest control means 102, and host control means 101 and controllable device 103 are connected to each other by logical connections, and host control means 101, guest control means 102, and controllable device 103 are physically connected to wireless station 106. Wireless station 106 and each means and each controlled device are configured and connected in an infrastructure mode. Furthermore, server 100 is physically connected to wireless station 106, and they are connected as subnets of the LAN.

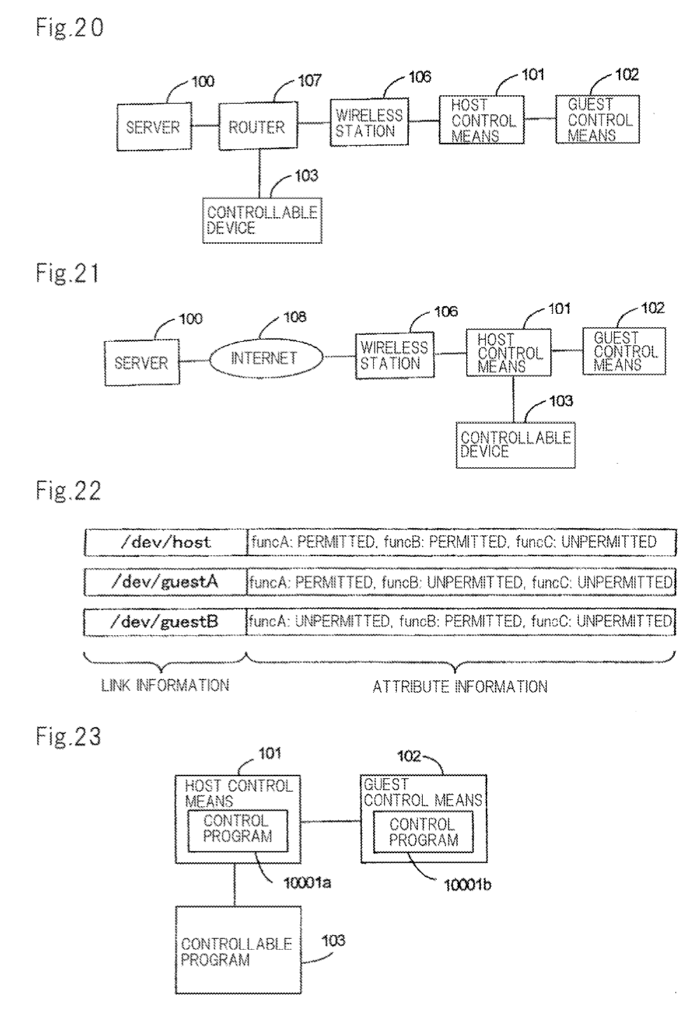

FIG. 20 is a diagram illustrative of a third exemplary embodiment of the present invention. The third exemplary embodiment includes newly added wireless station 106 and router 107 compared with the first exemplary embodiment, i.e. the third exemplary embodiment does not includes wireless station 106 and router 107. Controlled device 103 and server 100 are connected to router 107. Wireless station 106 and host control means 101 and host control means 101 and guest control means 102 are connected to each other by logical connections, and host control means 101 and guest control means 102 are physically connected to wireless station 106. Wireless station 106, host control means 101, and guest control means 102 are connected in an infrastructure mode. Controlled device 103 is connected to router 107 for the purpose of limiting control means connected to controllable device 103. For example, when a network protocol for controlling controllable device 103 is passed through router 107, pre-registered MAC addresses and IP addresses are used to prevent guest control means 102 from directly accessing controllable device 103.

FIG. 21 is a diagram illustrative of a fourth exemplary embodiment of the present invention. According to the fourth exemplary embodiment, wireless station 106 and Internet 108 are added to the first exemplary embodiment. If the connection route from wireless station 106 to Internet 108 is a public network, then wireless station 106 serves as a base station, and server 100 is present outside of the network including host control means 101, guest control means 102, and controllable device 103. Host control means 101 acquires a control program for operating controllable device 103 through the public network. If wireless station 106 serves as an access point, then wireless station 106 has a router function and can be connected to an external network.

FIG. 22 is a diagram showing another example different from the policy database shown in FIG. 14. As shown in FIG. 22, controlling controllable device 103 is not regarded as controlling function modules, but a control program is regarded as a program, and a policy database can be configured to limit a plurality of functions that a program has. The policy database comprises link information of locations where programs are present and attribute information for determining operational limitations with respect to individual functions used by a process. The attribute information represents function limiting information including funcA=permitted, funcB=permitted, funcC=unpermitted for a program /dev/host represented by the link information. When the above program performs the functions defined by func, a policy database check refers to the above attribute information and limits each func with a function limiter.

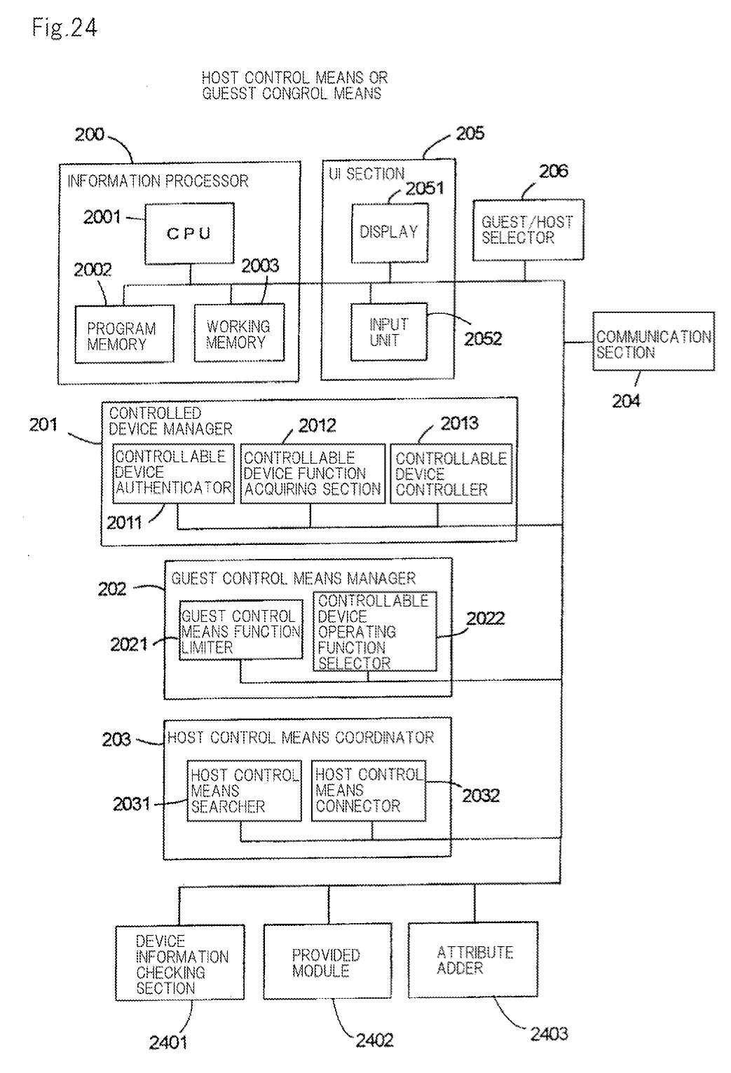

A fifth exemplary embodiment will be described below with reference to FIGS. 23 through 26. The fifth exemplary embodiment is different from the first exemplary embodiment in that host control means 101 has a function as a server (e.g., server 100 in FIG. 1). A peripheral device control system shown in FIG. 23 is free of server 100 according to the first exemplary embodiment, and has host control means 101 storing all control programs for controlling controllable device 103. FIGS. 24 through 26 correspond respectively to FIGS. 3 through 5, and corresponding components are denoted in principle by identical reference numerals.

FIG. 24 shows a “host control means or guest control means” in which, as is the case with the first exemplary embodiment, the user operates host/guest selector 206 to select the “host control means or guest control means” for use as a host control means or for use as a guest control means. The configuration shown in FIG. 24 is similar to the configuration shown in FIG. 3 with device information checking section 2401, provided module 2402, and attribute adder 2403 added thereto. These additional components correspond respectively to device information checking section 401, provided module 402, attribute adder 403 shown in FIG. 3.

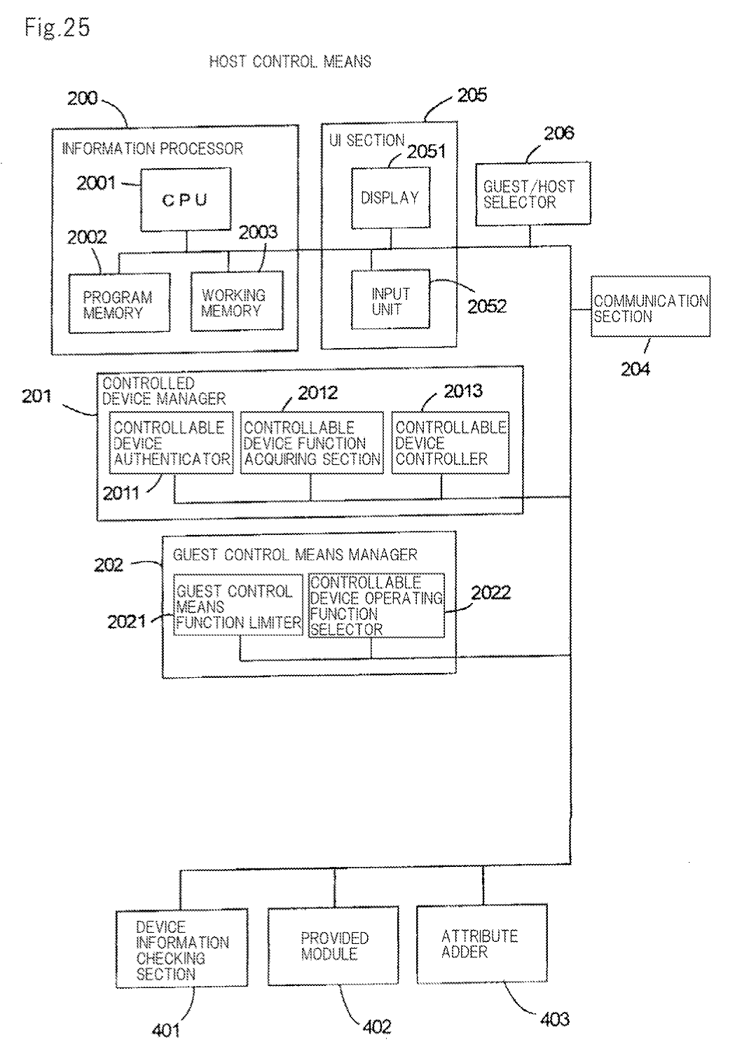

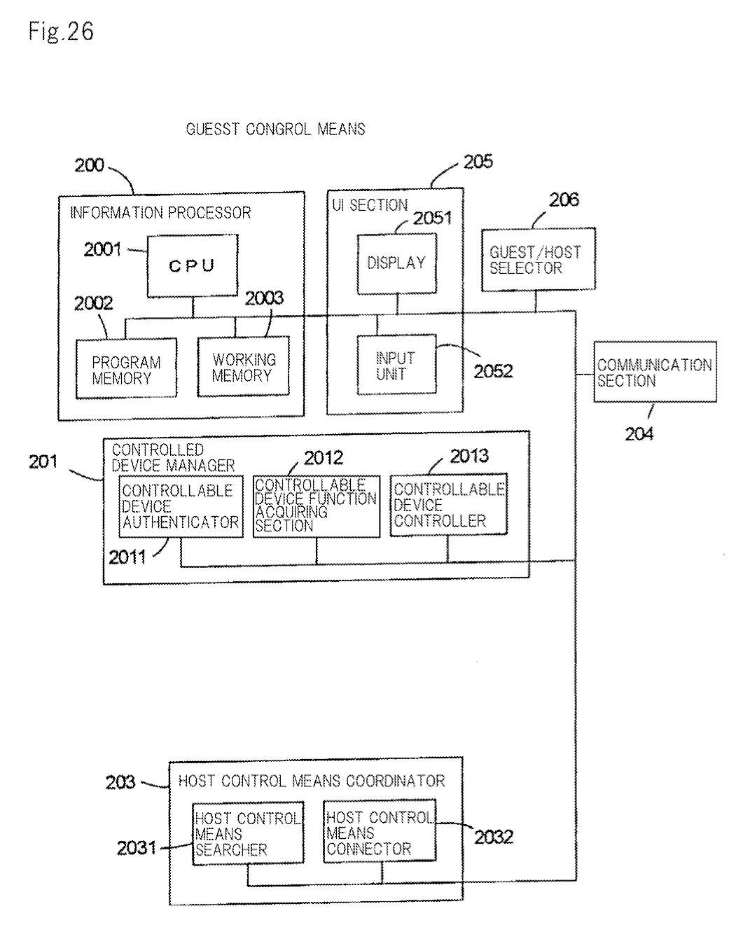

FIG. 25 is a diagram showing a configuration of the apparatus shown in FIG. 24 which is used as the host control means, and FIG. 26 is a diagram showing a configuration of the apparatus shown in FIG. 24 which is used as the guest control means.

Operation of the fifth exemplary embodiment will not be described in detail as it can easily be understood from the description of the first exemplary embodiment, etc.

### EXAMPLE 1

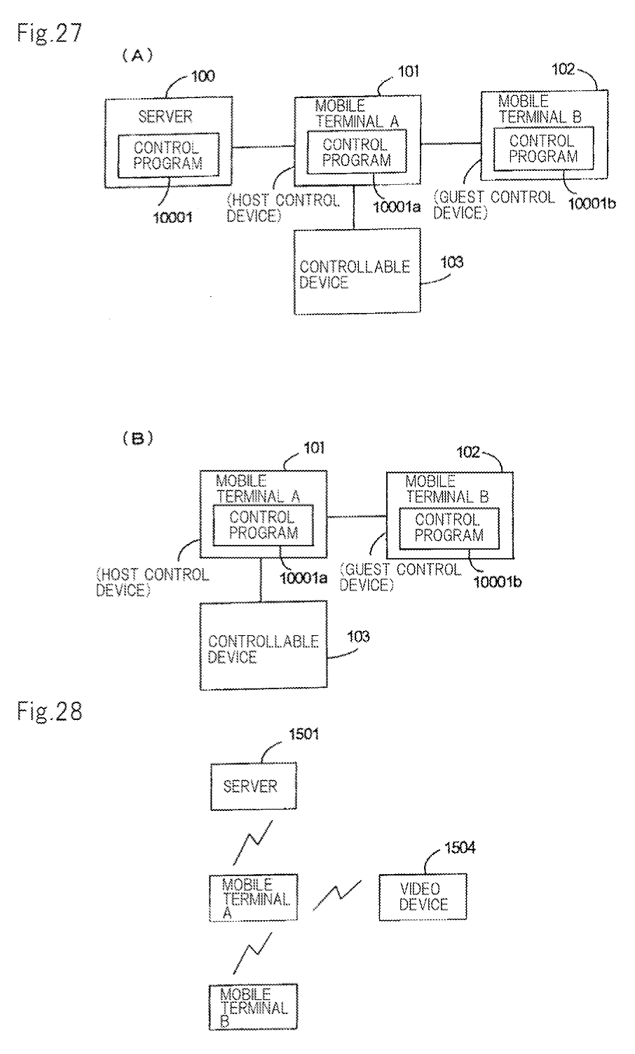

In the description so far, the host control means and the guest control means for controlling the controllable device has been described as a control means disposed in a PDA having a communication function or a control means disposed in a mobile communication terminal. According to the present invention, however, each host control means and each the guest control means can be taken as a device itself such as a PDA having a communication function or a mobile communication terminal (e.g., a mobile phone). In other words, according to the present invention, host control means 101 and guest control means 102 shown in FIG. 1 may be handled as mobile terminal A and mobile terminal B, respectively, as shown in FIG. 27(A).

According to the present invention, similarly, host control means 101 and guest control means 102 shown in FIG. 23 may be handled as mobile terminal A and mobile terminal B, respectively, as shown in FIG. 27(B). Operation of them as host and guest control devices shown in FIGS. 27(A), (B) is the same as those according to the exemplary embodiments described above.

### EXAMPLE 2

FIG. 28 is a block diagram illustrative of a specific system comprising server 1501, mobile terminal A, mobile terminal B, and video device 1504 according to the present invention. All of the components shown in FIG. 28 are connected in an ad-hoc mode of a wireless LAN. It is assumed that the owner of mobile terminal A (host owner) owns server 1501 and video device 1504. The owner of mobile terminal B (guest owner) is different from the owner of mobile terminal A, and control programs are acquired and video device 1504 is controlled through mobile terminal A. Server 1501 holds a control program for video device 1504, and this control program runs on mobile terminals A, B. The program for controlling video device 1504 is supplied from server 1501 upon request from mobile terminal A, and is available as a function module for an operation unit of a controllable device. Mobile terminal A determines whether the function module can be used or not, and sends information as to whether the function module can be used or not to server 1501. Based on the information as to whether the function module can be used or not, server 1501 assigns attribute information to each function module unit. The attribute information is used for mobile terminal A or B to limit operation of the function module.

For acquiring device information of video device 1504, mobile terminal A searches for information home electric appliances in the network in the wireless LAN ad-hoc mode. Video device 1504 has a user ID and a password registered therein which have been set in advance by the owner of mobile terminal A. If mobile terminal A searches for information home electric appliances and detects video device 1504, then mobile terminal A enters the user ID and the password registered in video device 1504 to log in video device 1504, and acquires a connection key to be used to operate video device 1504. The connection key is randomly generated by video device 1504. If a pre-registered user has successfully logged in, the connection key is given to the user and stored in mobile terminal A.

Generally, each of a plurality of mobile terminals should desirably have device information such as the type name and production number of the mobile terminal and discrimination information such as a unique ID thereof. If there is no such device information, then since a wireless LAN generally exchanges data according to IP communications, it is possible to use IP addresses to be uniquely assigned on the wireless LAN or MAC (Media Access Control) addresses to be uniquely assigned to communication devices.

Video device 1504 stores therein device information or a unique ID and the connection key in relation to each other, so that an unregistered mobile terminal user who has not successfully logged in cannot easily use a previously assigned connection key. If mobile terminal A has successfully logged in, then in order to acquire an operation program for video device 1504 from server 1501, mobile terminal A acquires device information for “identifying a control program” such as the maker name and type information of video device 1504, and functions held by video device 1504. Based on the held functions, mobile terminal A lets the host owner (in this case, the user of mobile terminal A) select a function which the host owner wants to use.

Mobile terminal A sends the above “selected function” and the above “device information.” to server 1501, and acquires a control program with attribute information for limiting the functions of video device 1504. If the owner of mobile terminal A (host owner) wants the owner of mobile terminal B (guest owner) to use video device 1504, then the host owner has mobile terminal B connect to mobile terminal A. In order to connect a permitted mobile terminal, the host owner has sent a temporary passkey to the guest owner. The owners of mobile terminal A and mobile terminal B enter the same passkeys. Mobile terminal B sends the passkey entered by the guest owner to mobile terminal A, and mobile terminal A compares the passkey received from mobile terminal B and the passkey entered by the host owner with each other. If the passkeys are in agreement with each other, then mobile terminal A sends a connection permission response to mobile terminal B, and enters a mode for accepting a request from mobile terminal B. Once mobile terminal A has entered the request accepting mode, it makes it possible to prevent an unrecognized mobile terminal from making an unauthorized acquisition of information by encrypting the communication path using the above passkey.

When mobile terminal A enters the request accepting mode, if there is a request for a list of usable information home electric appliances from mobile terminal B, mobile terminal A sends a response indicating that there is a device (in this case, video device 1504) which mobile terminal A itself can use. The response to the list request includes type information of information home electric appliances. The guest user selects a device which the guest user wants to operate from the list of usable devices that has been sent, and requests mobile terminal A to send a control program for the selected device (video device 1504). When requested by mobile terminal B for a control program for video device 1504, mobile terminal A has the host owner select functions which the host owner wants the guest owner to use, from the functions of video device 1504.

Since the host owner selects functions which the host owner wants the guest owner to use, the functions that can be used by mobile terminal B can be explicitly limited. The functions that can be used by mobile terminal B, among functions that video device 1504 has, are functions decreased from the functions that can be used by mobile terminal A which are given as a maximum range of functions. In this manner, the functions which cannot be operated by the host owner are prevented from being used in error by the guest owner. Based on the functions requested by mobile terminal B, mobile terminal A acquires a control program for controlling video device 1504 from server 1501, and sends the acquired control program to mobile terminal B.

In office applications, if the network administrator determines functions to be used by the owner of a host terminal which is administered thereby and sets the host terminal accordingly, then the following advantage is obtained: If a device such as a printer or the like connected to a network administered by the network administrator is to be used by a guest user after the host terminal is set, then it is possible to limit the functions that can be used by the guest user on the responsibility of the owner of the host terminal without having to set again functions that can be used by the terminal of the guest user.

The functions that can be used by mobile terminal A and mobile terminal B are limited by function limiter 5011 in the OS layer shown in FIG. 8 based on the attribute information indicating whether they can be used or not, and the attribute information is attached by server 1501. Thus, an unauthorized program is prevented from changing the attribute information within mobile terminal A.

If mobile terminal B operates video device 1504, then mobile terminal B uses host control means connector 2032 shown in FIG. 5 to send an operation command for video device 1504 to mobile terminal A. Mobile terminal A checks and limits the received operation command based on function modules which mobile terminal A has permitted mobile terminal B to use and attribute information thereof, with guest control means function limiter 2021 (see FIG. 8). In order to bring the attribute information and function modules of mobile terminal B, which are registered in the policy database into agreement, the policy database has registered therein a set of link information and attribute information of the links as shown in FIG. 14.

With the functions being thus limited, even if mobile terminal B makes an unauthorized attempt to use functions that the host owner has not permitted, guest control means function limiter 2021 (FIG. 4) limits the use thereof. Furthermore, mobile terminal B can operate video device 1504 through mobile terminal A. In other words, even if mobile terminal B attempts to directly operate video device 1504, mobile terminal B is unable to acquire a connection key because mobile terminal B is not registered as a user in video device 1504.

### EXAMPLE 3

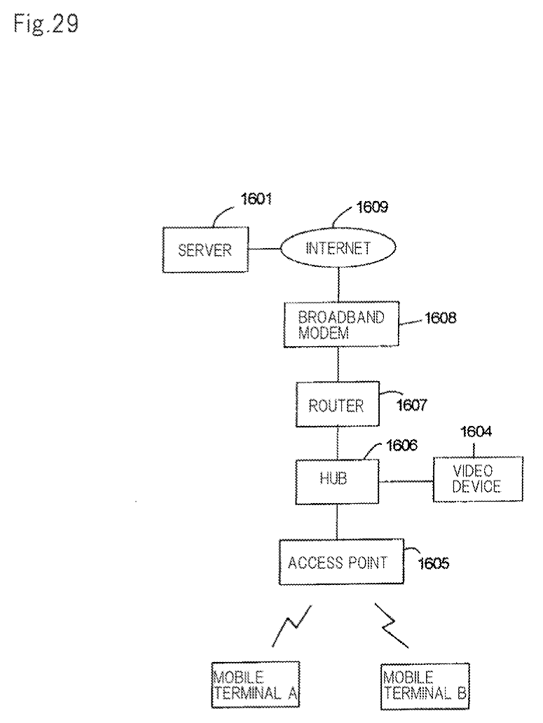

Example 3 will be described below with reference to FIG. 29. Example 3 comprises server 1601, mobile terminal A, mobile terminal B, video device 1504, access point 1605, hub 1606, router 1607, broadband modem 1608 such as an ADSL (Asymmetric Digital Subscriber Line) modem or the like, and Internet 1609. Example 3 is different from example 1 in that mobile terminal A and mobile terminal B are connected to access point 1605, and access point 1605 and mobile terminals A, B are connected in an infrastructure mode of a wireless LAN.

Server 1601 is a server provided by a maker of an information home electric appliance such as video device 1604, for example. This server is present on an external network which is different from a network to which mobile terminal A belongs. Hub 1606 is a device for connecting devices in the LAN to a network such as Ethernet (registered trademark). Router 1607 is a device for separating the LAN from the external network, and serves as a repeater for connecting Internet 1609 and the LAN to each other for IP (Internet Protocol). Modem 1608 is a modem device for connecting to a public network such as a circuit network. It is assumed that the owner of mobile terminal A (host owner) owns video device 1604.

Example 3 is of the above configuration. A sequence for mobile terminal A to connect to video device 1604, a sequence for mobile terminal A to download a program for controlling video device 1604 from server 1601, a sequence for mobile terminal B to acquire a control program for video device 1604 through mobile terminal A, a sequence for mobile terminal B to operate video device 1604 through mobile terminal A, and a sequence for limiting usable operations with respect to mobile terminal B can easily be understood from the description so far.

Although the present invention has been described above with respect to the exemplary embodiments (and the examples), the present invention is not limited to the exemplary embodiments (and the examples) described above. Various changes that can be understood by those skilled in the art can be made in the configurations and details of the present invention within the scope of the invention.

The present application claims priority based on Japanese patent application No. 2007-024096 filed on Feb. 2, 2007, and incorporates herein the entire disclosure thereof by reference.

1. A control system for controlling a controllable device such as a peripheral device, comprising:
server means for providing a control program, for controlling the controllable device, to a host control means and a guest control means;
wherein said host control means controls the controllable device according to said control program, intermediates between the guest control means and the controllable device, limits functions of the controllable device which can be controlled by the guest control means, and confirms a control request issued by the guest control means to the controllable device; and
said guest control means can be connected to the controllable device through the host control means.

2. The control system according to claim 1, wherein said guest control means controls the controllable device for the functions of the controllable device which can be controlled by the host control means as a maximum range of functions.

3. The control system according to claim 1, wherein a network between the host control means and the guest control means is logically separate from a network between the host control means and the controllable device or is logically separate from a network between the host control means and the server.

4. The control system according to claim 1, wherein the host control means and the guest control means are of an identical configuration, and each have operation switching means which is set for determining whether each host control means and each the guest control means is to be operated as a host control means or a guest control means.

5. The control system according to claim 1, wherein the host control means comprises:
an information processor;
a user interface section serving as an interface with its own user;
an authenticator for authenticating the controllable device;
a controllable device function acquiring section for acquiring function information which the control device has;
a controllable device controller for controlling the controllable device;
means for relaying a control request to be sent from the guest control means to the controllable device, inspecting the control request before being relayed, and limiting the execution of the control request based on a pre-registered policy; and
a communication section for communicating with the server means, the guest control means, and the controllable device.

6. The control system according to claim 1, wherein the guest control means comprises:
an information processor;
a user interface section serving as an interface with its own user;
an authenticator for authenticating the controllable device;
a controllable device function acquiring section for acquiring function information which the control device has;
a controllable device controller for controlling the controllable device;
a searcher for searching for the host control means;
a host control means connector for connecting to the host control means which is searched for; and
a communication section for communicating with the host control means.

7. The control system according to claim 1, wherein the server means comprises:
an information processor;
means for checking device information about the controllable device and the host control means or the guest control means against device information received through the host control means and held by itself, and selecting a function module as the control program to be provided to the host control means or the guest control means;
an attribute adder for attaching attribute information to the function module; and
a communication section for communicating with the host control means.

8. The control system according to claim 1, wherein each host control means and. each the guest control means comprises inspecting means for registering the attribute information attached to the function module received from the server means in a database, and inspecting whether the function module stored in each of the control means can be operated or not based on the database, said inspecting means being interlinked with means for limiting operation of the function module.

9. The control system according to claim 1, wherein the controllable device pre-records log-in information of the user of the host control means which uses the controllable device, determines whether log-in information sent from said host control means and the pre-recorded log-in information are in. conformity with each other or not, and, if they are in conformity with each other, sends “device information for identifying itself” and “a connection key to be used when the host control means accesses the controllable device” to the host control means.

10. The control system according to claim 9, wherein said connection key has a randomly assigned value.

11. The control system according to claim 9, wherein if the controllable device confirms that log-in information of the user sent from said host control means and the log-in information recorded therein are in conformity with each other, the controllable device sends a function list thereof to the host control means.

12. The control system according to claim 11, wherein the host control means has the user thereof select functions which the user wants to use from the function list received from the controllable device.

13. The control system according to claim 12, wherein the host control means has the user thereof select functions of the controllable device which the user of the guest control means is permitted to use.

14. The control system according to claim 13, wherein the host control means permits the user of the guest control means to use the functions of the controllable device which the host control means can use, as an upper-limit range of functions.

15. The control system according to claim 1, wherein each host control means and each the guest control means comprises a mobile information communication terminal such as a mobile phone.

16. A control system for controlling a controllable device such as a peripheral device using host control means and guest control means, wherein:
said host control means holds a control program for controlling the controllable device, controls the controllable device according to the control program, provides the control program to the guest control means, intermediates between the guest control means and the controllable device when the guest control means controls the controllable device, limits functions of the controllable device which can be controlled by the guest control means, and confirms a control request issued by the guest control means to the controllable device; and
said guest control means can be connected to the controllable device through the host control means.

17. The control system according to claim 16, wherein said guest control means controls the controllable device for the functions of the controllable device which can be controlled by the host control means as a maximum range of functions.

18. The control system according to claim 16, wherein a network between the host control means and the guest control means is logically separate from a network between the host control means and the controllable device.

19. The control system according to claim 16, wherein the host control means and the guest control means 5 are of an identical configuration, and each have operation switching means which is set for determining whether each host control means and each the guest control means is to be operated as a host control means or a guest control means.

20. The control system according to claim 16, wherein the host control means comprises:
an information processor;
a user interface section serving as an interface with its own user;
an authenticator for authenticating the controllable device;
a controllable device function acquiring section for acquiring function information which the control device has;
a controllable device controller for controlling the controllable device;
means for relaying a control request to be sent from the guest control means to the controllable device, inspecting the control request before being relayed, and limiting the execution of the control request based on a pre-registered policy;
a communication section for communicating with the guest control means and the controllable device;
means for receiving and checking device information about the controllable device against device information held by itself, and selecting a function module as the control program provided to the guest control means; and
an attribute adder for attaching attribute information to the function module.

21. The control system according to claim 16, wherein the guest control means comprises:
an information processor;
a user interface section serving as an interface with its own user;
an authenticator for authenticating the controllable device;
a controllable device function acquiring section for acquiring function information which the control device has;
a controllable device controller for controlling the controllable device;
a searcher for searching for the host control means;
a host control means connector for connecting to the host control means which is searched for; and
a communication section for communicating with the host control means.

22. The control system according to claim 16, wherein the guest control means comprises inspecting means for registering the attribute information attached to the function module received from the server means in a database, and inspecting whether or not the function module stored in each of the control means can be operated based on the database, said inspecting means being interlinked with means for limiting operation of the function module.

23. The control system according to claim 16, wherein the controllable device pre-records log-in information of the user of the host control means which uses the controllable device, determines whether or not log-in information sent from said host control means and the pre-recorded log-in information are in conformity with each other, and, if they are in conformity with each other, sends “device information for identifying itself” and “a connection key to be used when the host control means accesses the controllable device” for the host control means.

24. The control system according to claim 23, wherein said connection key has a randomly assigned value.

25. The control system according to claim 23, wherein if the controllable device confirms that log-in information of the user sent from said host control means and if the log-in information recorded therein are in conformity with each other, the controllable device sends a function list thereof to the host control means.

26. The control system according to claim 25, wherein the host control means has the user thereof select functions which the user wants to use from the function list received from the controllable device.

27. The control system according to claim 26, wherein the host control means has the user thereof select functions of the controllable device which the user of the guest control means is permitted to use.

28. The control system according to claim 27, wherein the host control means permits the user of the guest control means to use the functions of the controllable device which the host control means can use, as an upper-limit range of functions.

29. The control system according to claim 16, wherein each host control means and each the guest control means comprises a mobile information communication terminal such as a mobile phone.

30. A control method of controlling a controllable device such as a peripheral device using host control means or guest control means, wherein said host control means performs:
a process of having a user of the host control means enter log-in information to be sent to the controllable device;
a process of sending the entered log-in information to the controllable device;
a process of acquiring device information about the controllable device and a list of functions which the controllable device has from the controllable device;
a process of having the user of the host control means select functions which the user of the host control wants to use from said function list;
a process of sending said device information and a list of the functions selected by the user to a server, and requesting and acquiring a control program having control attributes; and
a process of controlling the controllable device for functions permitted based on the control attributes attached to the acquired control program.

31. The control method according to claim 30, wherein said host control means performs:
a process of requesting the guest control means to send a connection key when the guest control means requests a connection to the host control means;
a process of providing a list of controllable devices which can be used by the guest control means to the guest control means and having the guest control means select one of the controllable devices;
a process of having an owner of the host control means select the controllable device selected by the guest control means and functions of the selected controllable device which can be used by the guest control means, within a range of functions which are used by the host control means;
a process of sending a list of the functions selected by the owner of the host control means and device information of the controllable device to a server, and acquiring a program for controlling the controllable device; and
a process of sending the acquired program to the controllable device.

32. The control method according to claim 30, wherein said host control means performs:
a process of relaying a control command requested by the guest control means for the controllable device to the controllable device; and
a process of determining whether or not said control command is controllable based on control attribute information given to the guest control means, and sending the control command which is judged as controllable to the controllable device.

33. The control method according to claim 30, wherein said guest control means performs:
a process of having an owner of the guest control means enter a connection key;
a process of sending the connection key to the host control device;
a process of selecting a controllable device which the owner of the guest control means is desirous of using from the list of controllable devices acquired from the host control means which can be used by the owner of the guest control means;
a process of acquiring a program having control attributes of the selected controllable device from said server through said host control device; and
a process of making the controllable device available through the host control means based on the control attributes attached to said program.

34. The control method according to claim 30, wherein said host control means performs:
a process of pre-registering user information including a user ID and a password of the user of the host control means in the controllable device; and
the controllable device checks the pre-registered user information against user information which is sent when the host control means uses the controllable device, and, if the pre-registered user information and the sent user information are in conformity with each other, sends the device information of the controllable device to the host control means, and sends a connection key to be used when the host control means controls the controllable device and a list of functions which the controllable device has to the host control means.

35. A computer program for carrying out a control method according to claim 30.

36. A control method of controlling a controllable device such as a peripheral device with host control means or guest control means, wherein said host control means performs:
a process of pre-storing a program for controlling functions of the controllable device;
said host control device performs:
a process of having a user of the host control means enter log-in information to be sent to the controllable device;
a process of sending the entered log-in information to the controllable device;
a process of device information about the controllable device and acquiring a list of functions which the controllable device has from the controllable device;
a process of having the user of the host control means select functions which the user of the host control means wants to use from the list of functions;
a process of identifying a control program from said device information and a list of the functions selected by the user; and
a process of controlling the controllable device for “functions permitted” based on control attributes added to the identified control program.

37. The control method according to claim 36, wherein said host control means performs:
a process of requesting the guest control means to send a connection key when the guest control means requests a connection to the host control means;
a process of providing a list of controllable devices which can be used by the guest control means to the guest control means and having the guest control means select one of the controllable devices;
a process of having an owner of the host control means select the controllable device selected by the guest control means and functions of the selected controllable device which can be used by the guest control means from, within a range of functions which are used by the host control means;
a process of identifying a program controllable by the guest control means based on a list of the functions selected by the owner of the host control means and device information of the controllable device; and
a process of sending the identified program to the controllable device.

38. The control method according to claim 36, wherein said host control means performs:
a process of relaying a control command requested by the guest control means for the controllable device to the controllable device; and
a process of determining whether or not said control command is controllable based on control attribute information given to the guest control means, and sending the control command which is judged as controllable to the controllable device.

39. The control method according to claim 36, wherein said guest control means performs:
a process of having an owner of the guest control means enter a connection key;
a process of sending the connection key to the host control device;
a process of selecting a controllable device which the owner of the guest control means is desirous of using from the list of controllable devices acquired from the host control means which can be used by the owner of the guest control means;
a process of acquiring a program having control attributes of the selected controllable device from said server through said host control device; and
a process of making the controllable device available through the host control means based on the control attributes attached to said program.

40. The control method according to claim 36, wherein said host control means performs:
a process of pre-registering user information including a user ID and a password of the user of the host control means in the controllable device; and
the controllable device checks the pre-registered user information against user information which is sent when the host control means uses the controllable device, and, if the pre-registered user information and the sent user information are in conformity with each other, sends the device information of the controllable device to the host control means, and sends a connection key to be used when the host control means controls the controllable device and a list of functions which the controllable device has to the host control means.

41. A computer program for carrying out a control method according to claim 36.
